(19) United States
(12) Patent Application Publication
(10) Pub. No.: US 2024/0051248 A1
(43) Pub. Date: Feb. 15, 2024

(54) BREAKDOWN SERVICE APPARATUS HAVING BATTERY, METHOD FOR SEALING AND PUMPING UP VEHICLE TIRES, AND SYSTEM FOR CHARGING A BREAKDOWN SERVICE APPARATUS

(71) Applicant: Continental Reifen Deutschland GmbH, Hannover (DE)

(72) Inventor: Florian Schlosser, Barsinghausen (DE)

(73) Assignee: Continental Reifen Deutschland GmbH, Hannover, OT (DE)

(21) Appl. No.: 18/257,969

(22) PCT Filed: Nov. 18, 2021
(86) PCT No.: PCT/DE2021/200194

§ 371 Date: Jun. 16, 2023

(30) Foreign Application Priority Data
Dec. 16, 2020 (DE) 10 2020 216 050.3

(51) Int. Cl. B29C 73/16

(52) U.S. Cl. CPC B29C 73/166; B29L 2030/00

(57) ABSTRACT

The invention relates to a puncture assistance device 1 for sealing and inflating vehicle tires, comprising a pressure source, the puncture assistance device 1 having at least one battery, which supplies power to the pressure source. The invention also relates to a method for charging such a puncture assistance device 1, the puncture assistance device 1 being charged in a vehicle by means of a power supply interface 9 and/or inductively. The invention is directed to a system for charging a puncture assistance device 1, comprising a vehicle with an inductive charging surface, and a puncture assistance device 1 of this type, the puncture assistance device 1 being arranged in the charging region of the inductive charging surface in the vehicle.

The invention relates to a puncture assistance device for sealing and inflating vehicle tires according to the preamble of patent claim 1. Furthermore, the invention relates to a method for sealing and inflating vehicle tires according to the preamble of patent claim 9, and to a system for charging a puncture assistance device according to the preamble of patent claim 10.

Puncture assistance devices are known in the prior art and are used in particular when vehicle tires suffer damage in the form of holes when driving over sharp objects, for example. In addition to the option of using a spare tire, as development progresses, puncture assistance kits or puncture kits are being accommodated in a vehicle for weight saving purposes, these being able to be used in the event of vehicle tire damage. Such puncture assistance kits generally comprise a compressor for generating compressed air and a sealant that is introduced into the damaged vehicle tire. DE 102016209302 A1 discloses for example a method for sealing and inflating inflatable objects, in particular for sealing and inflating motor vehicle tires, and a device having a compressor for performing such a method. The sealant required for such puncture assistance kits may be applied either manually by the user (squeeze system) or with the aid of a compressor (pump system).

Since such a compressor requires a power supply, current puncture assistance kits have to be connected to the vehicle on-board power socket by way of a cable. Consequently, the puncture assistance devices are dependent on the length of the cable and on the power outlet on the vehicle. The use of current puncture assistance kits is problematic when the vehicle tire is too far away from the power source in the case of a puncture.

This is where the present invention comes into play. It is the object of the present invention to provide a puncture assistance device which can be used flexibly. Furthermore, it is the object of the invention to provide a method for charging a puncture assistance device of this type, in the case of which method the puncture assistance device can be used flexibly.

This object is achieved by way of a puncture assistance device with the features of claim 1, by way of a method for sealing and inflating vehicle tires with the features of claim 9, and a system for charging a puncture assistance device with the features of claim 10.

The object is achieved by a puncture assistance device for sealing and inflating vehicle tires, comprising a pressure source, the puncture assistance device having at least one battery, which supplies power to the pressure source. The puncture assistance device can consequently be advantageously used independently of a power source. This is advantageous, in particular, when the power source is too far away from the damaged vehicle tire. The device can be connected to any desired vehicle tire and used independently of the cable length. This is a considerable advantage for the user, since the use of the puncture assistance device is considerably simplified in this way.

According to the invention, the battery is configured in such a way that the battery supplies the pressure source with sufficient power. The pressure source generates sufficient air to fill the vehicle tire with air. In addition, sufficient air is generated to fill the vehicle tire with a sealant and to seal the vehicle tire by way of a sealant.

Different types of batteries are conceivable. For example, a commercially available 12 V battery can be used. All commercially available rechargeable batteries are conceivable, for example all types of lithium ions, nickel metal hydride or else non-rechargeable batteries for single use, for example alkaline manganese batteries.

In one embodiment of the invention, the pressure source is a compressor which comprises an electric motor and, in particular, a motor control device, the electric motor particularly preferably being designed only for a nominal voltage of at least 12 volts. The compressor advantageously generates pressure to pump the air or the sealant into the vehicle tire. An optional motor control device can control and regulate the electric motor. It is conceivable for the motor control device to be an on/off button. Other motor control devices which are configured to control or to regulate the motor are likewise conceivable, however. The electric motor is an electromechanical converter that converts electric power into mechanical power. The electric motor is usually connected to the motor control device, and is designed for the power output which is individually required to generate compressed air by way of the compressor for inflating a vehicle tire. The battery is correspondingly configured in such a way that it can provide sufficient power output to supply the electric motor with power.

In one preferred embodiment, the battery is rechargeable, in particular by means of induction. The battery can advantageously be recharged for multiple applications of the puncture assistance device. The recharging can take place via external recharging systems for batteries. The recharging particularly preferably takes place via induction, however, as a result of which the batteries can remain in the puncture assistance device while they are being charged. The puncture assistance device can advantageously be made ready for operation again in a simple way.

In one particularly preferred embodiment, the device comprises an interface for power supply which is at least configured to recharge the battery and/or to supply the pressure source with power. The batteries can advantageously be recharged via the interface, without having to be removed from the device. In addition, the puncture assistance device can be additionally supplied with power in the case of insufficiently charged batteries. The interface is preferably an interface selected from the group consisting of a USB interface, a Lightning interface, a Thunderbolt interface, a customary plug and a cigarette lighter in a vehicle. To this end, the puncture assistance device can comprise either the interface for connecting a cable, or a cable which the interface has at its end. In addition to the possibility that the puncture assistance device can be charged in a vehicle or at a conventional plug, charging by way of a power bank is conceivable as an alternative. A power bank is a mobile power source which can be used to charge the puncture assistance device during transport. Therefore, the puncture assistance device can be used considerably more flexibly, since it can both be used independently of the power source and can be recharged flexibly.

The battery can preferably produce at least 5 watt-hours, preferably at least 20 watt-hours.

In a typical application, the battery is designed for at least 20 watt-hours; 120 watts should be produced for 10 minutes in order for it to be possible for the vehicle tire to be sealed and inflated in an optimum manner. The more rapidly the vehicle tire is repaired, the more advantageous this is for the user.

The battery can further preferably produce a power output of at least 60 watts, in particular 80 watts. This power output is advantageously optimum as a function of time for sealing and inflating a vehicle tire.

In a further preferred embodiment, the puncture assistance device has a display device, in particular a battery filling level indicator. The display device can be, for example, a display, by way of which the puncture assistance device can display relevant information. For example, the filling level of the sealant or the process operation of sealing and inflating can be indicated. The user can advantageously read off important information which they require for operating the unit. The display device is particularly preferably a battery filling level indicator which indicates how full the at least one battery is. The user can thus determine whether the rechargeable battery charging state of the puncture assistance device is sufficient, and whether the device can be used completely for a next use.

Furthermore, the device preferably comprises an electronic control unit which controls at least the battery and the pressure source, and preferably additionally the interface. The electronic control unit communicates with the at least one battery and the pressure source, for example the compressor, in order to control or to regulate the power supply. It is conceivable that the electronic control unit is connected to the above-described display device, via which the user can control the individual components of the puncture assistance device. It is advantageous that individual components can be operated and controlled individually.

The puncture assistance device further preferably comprises at least one lamp, in particular a flashlight. A lamp can be helpful, for example, at dusk or in the dark, in order to facilitate the use of the puncture assistance device. As an alternative, a lamp can report information. For example, a lamp can indicate to the user whether the operation of sealing is concluded. The use is advantageously substantially facilitated by way of a lamp of this type.

In a further preferred embodiment, the device comprises a feed opening for feeding in a sealant, which feed opening can be controlled, in particular, via the electronic control unit. In the unused state, the feed opening usually has a seal or a sealing cap which can be unscrewed in the case of use. The sealing cap protects against undesired contamination. The feed opening is particularly preferably connected to the electronic control unit, with the result that the feed of the sealant can be controlled or regulated. It is conceivable, furthermore, that a sensor is attached to the feed opening, which sensor can measure how much sealant is still running through the feed opening. It is advantageous for the user that the sensor can determine whether a switchover to the pump mode only with air can be carried out.

In a further preferred embodiment, the device comprises a sealant container, it being possible, in particular, for the feed of the sealant to be controlled via the above-described electronic control unit. The sealant is stored in the sealant container, it being possible for the container to either be installed in the housing or to be fastened to the housing, in particular to the above-described feed opening. One substantial advantage is that the sealant container can be exchanged more easily outside the housing. When it is empty, it can be unscrewed from the feed opening and a new container can be screwed onto the latter. Overall, the puncture assistance device can therefore be used multiple times.

Furthermore, the present invention is directed to a method for sealing and inflating vehicle tires with an above-described puncture assistance device, comprising the steps:
connecting of a puncture assistance device to a vehicle tire,
sealing and inflating of the vehicle tire,
removing of the puncture assistance device, and
charging of the puncture assistance device in a vehicle via an interface for power supply and/or inductively.

The method is advantageous for the user, since they can use the puncture assistance device flexibly and can subsequently recharge it in the vehicle.

The above-described features which relate to the puncture assistance device and the preferred embodiments also relate, vice versa, to the method according to the invention.

The puncture assistance device is usually stored in a vehicle, for example in the trunk. In the case of a puncture, the device is used to seal and inflate the vehicle tire. When the battery has been emptied by this use, it can be recharged. To this end, the device can subsequently be stored, for example in a storage compartment in the vehicle, and can be supplied with power via the interface. It is also conceivable, however, that the storage compartment has an inductive surface, via which the puncture assistance device is charged.

Furthermore, the invention is directed to a system for charging a puncture assistance device, comprising a vehicle with an inductive charging surface, and an above-described puncture assistance device, the puncture assistance device being arranged in the charging region of the inductive charging surface in the vehicle. The puncture assistance device is advantageously always flexibly ready for use, since the device is always supplied with sufficient energy during the storage time in the vehicle. The user can therefore use the puncture assistance device flexibly everywhere.

Further advantages and features of the device according to the invention and the method and the system result from the subclaims which relate to advantageous embodiments of the present invention and as such are not to be understood to be restrictive. The invention also encompasses combinations of the features of different dependent claims where technically possible, even if the dependent claims do not relate to one another or if they belong to different claim categories. Furthermore, combinations of preferred and particularly preferred embodiments among one another can also be combined with one another, in so far as they are technically possible. This is also true of the individual features of the exemplary embodiments discussed hereinafter to the extent that the person skilled in the art is unable to recognize these as necessarily belonging together.

### DESCRIPTION OF THE FIGURES

Further details and advantages of the present invention will become apparent from the following description of the exemplary embodiment in conjunction with the drawing, in which:

FIG. 1 shows one embodiment of the puncture assistance device according to the invention in an oblique side view.

FIG. 1 shows an oblique side view of a puncture assistance device 1 for sealing and inflating a vehicle tire. In order to seal the vehicle tire, a container with sealant can be connected to the feed opening 2. To this end, the cap 3 of the feed opening 2 is screwed open in the direction of the arrow, and the container with sealant is screwed onto the feed opening 2. Subsequently, the puncture assistance device 1 can be switched on via the toggle switch 4, a battery filling level indicator 5 indicating the filling level of the batteries. The battery filling level indicator 5 indicates the filling level with the aid of four lamps, by the number of illuminated lamps representing the filling level. By way of example, the batteries are full when all four lamps illuminate. A pressure indicator 6 indicates the air pressure in the tire. The puncture assistance device 1 has air inlet openings 7 for the compressor, since the latter is arranged in the housing and has to suck in air, in order then to transport sealant or air into the pneumatic vehicle tire. Furthermore, the puncture assistance device 1 has a battery compartment 8, in which the at least one battery is arranged and by way of which the at least one battery can be replaced. Moreover, the puncture assistance device 1 has a USB interface 9, by way of which the battery can be charged.

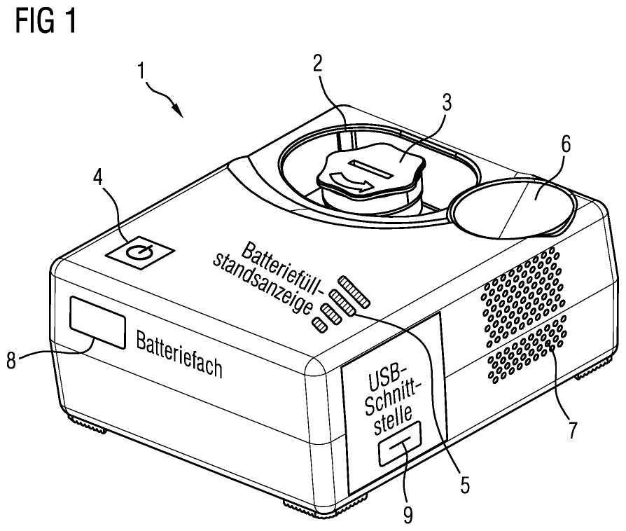

### LIST OF DESIGNATIONS

1 puncture assistance device
2 feed opening
3 cap
4 toggle switch
5 battery filling level indicator
6 pressure indicator
7 air inlet opening
8 battery compartment
9 USB interface

1.-10. (canceled)

11. A puncture assistance device for sealing and inflating vehicle tires, comprising:
a compressor having an electric motor to generate air with a sealant and fill a tire with the generated air with the sealant, the sealant seals a puncture in the tire;
a motor control coupled to the electric motor to control and relate the motor; and
a power source coupled to the pressure source to provide suitable power to the pressure source to provide sufficient air.

12. The device of claim 11, the power source includes a battery rechargeable by induction.

13. The device of claim 12, further comprising an interface for power supply which is at least configured to charge the battery and/or to supply the pressure source with power.

14. The device of claim 11, the battery can produce at least 5 watt-hours, preferably 20 watt-hours.

15. The device of claim 11, the puncture assistance device comprises a display device having a battery filling level indicator.

16. The device of claim 11, the device comprises an electronic control unit which controls at least the battery and the pressure source, and preferably additionally the interface.

17. The device of claim 16, the device (1) comprises a feed opening (2) for feeding in a sealant, which feed opening (2) can be controlled by the electronic control unit.

18. The device of claim 17, the device comprises a sealant container, a feed of the sealant to the tire is controlled via the electronic control unit.

19. The device of claim 18, further comprising an inductive charging surface of a vehicle coupled to the power source.

20. A method for sealing and inflating vehicle tires with a puncture assistance device, the method comprising:
connecting of a puncture assistance device (1) to a vehicle tire,
sealing and inflating of the vehicle tire,
removing of the puncture assistance device (1), and
charging of the puncture assistance device (1) in a vehicle via an interface for power supply and/or inductively.
